(19) United States
(12) Patent Application Publication
(10) Pub. No.: US 2026/0141595 A1
(43) Pub. Date: May 21, 2026

(54) CONTEXT-BASED GRAPHICAL ELEMENT REPLACEMENT

(71) Applicant: Infosys Limited, Bangalore (IN)

(72) Inventors: Sebastian WESTON-LEWIS, London (GB); Himanshu Gupta, Chandigarh (IN); Kartik Madan, Gurugram (IN)

(73) Assignee: Infosys Limited, Bangalore (IN)

(21) Appl. No.: 19/058,681

(22) Filed: Feb. 20, 2025

(30) Foreign Application Priority Data
Nov. 15, 2024 (IN) 202441088552

(51) Int. Cl. G06T 11/60

(52) U.S. Cl. CPC G06T 11/60

(57) ABSTRACT

A system for context-based graphical element replacement is provided. Various graphical elements (e.g., images, icons, or the like) are detected in a source file. For each graphical element, a visual context of the graphical element and one or more additional contexts are determined. The one or more additional contexts include a context associated with information present within a predefined range of the graphical element, a visual context of at least one other graphical element, and a context associated with the source file. A replacement graphical element is then generated for each detected graphical element based on the determined visual context and the one or more additional contexts associated with the corresponding graphical element. The graphical elements in the source file are replaced with the replacement graphical elements to generate a replacement file. The replacement file is then rendered on a user device.

### FIELD OF THE DISCLOSURE

Various embodiments of the present disclosure relate generally to digital data processing. More specifically, various embodiments of the present disclosure relate to context-based graphical element replacement.

### BACKGROUND

The current advancements in digital data processing using machine learning algorithms have significantly transformed various applications, ranging from digital media to augmented reality. The significant contribution of machine learning is the ability to dynamically modify or enhance any kind of content in a manner that preserves or enhances appearance and user experience. Current techniques in image processing often involve basic modifications such as filtering, cropping, or resizing. Some conventional methods may replace damaged or unwanted portions of an image with generic content. While these methods can improve visual quality, they typically do not address the broader context embedded within the images themselves. Thus, such modifications may not align well with the surrounding context, leading to inconsistencies and a diminished visual experience.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for context-based graphical element replacement are provided substantially as shown in, and described in connection with, at least one of the figures.

The systems disclosed herein include processing circuitry. The processing circuitry is configured to detect a plurality of graphical elements in a source file. The processing circuitry is further configured to determine a visual context of a first graphical element of the plurality of graphical elements and determine one or more additional contexts associated with the first graphical element. The one or more additional contexts comprise at least one of a group consisting of (i) a context associated with information present within a predefined range of the first graphical element, (ii) a visual context of at least one other graphical element of the plurality of graphical elements, or (iii) a context associated with the source file. The processing circuitry is further configured to generate a plurality of replacement graphical elements for the plurality of graphical elements, with a first replacement graphical element being generated for the first graphical element based on the visual context of the first graphical element and the one or more additional contexts associated with the first graphical element.

In some embodiments, the first replacement graphical element is contextually analogous to and visually different from the first graphical element.

In some embodiments, the context associated with the information present within the predefined range of the first graphical element is at least one of visual or textual.

In some embodiments, the context associated with the source file is at least one of visual or textual.

In some embodiments, the processing circuitry is further configured to replace the plurality of graphical elements in the source file with the plurality of replacement graphical elements to generate a replacement file.

In some embodiments, the processing circuitry is further configured to render the replacement file on a user device associated with the system.

In some embodiments, the processing circuitry is further configured to validate the replacement file.

In some embodiments, to validate the replacement file, the processing circuitry is further configured to compare the replacement file and the source file to determine a degree of similarity therebetween. The replacement file is validated based on the degree of similarity being within a tolerance range.

In some embodiments, the processing circuitry is further configured to encrypt the first graphical element using an encryption key. The processing circuitry is further configured to create an audit log, where an entry in the audit log includes a mapping between the encrypted first graphical element and the encryption key. The first replacement graphical element includes metadata associated with the entry.

In some embodiments, the processing circuitry is further configured to recreate the source file from the replacement file based on the audit log.

In some embodiments, the processing circuitry determines the one or more additional contexts based on at least one of a code analysis or a visual analysis of the source file.

In some embodiments, the visual analysis corresponds to analysis of at least one of a group consisting of whitespaces, lines, color, contrast, or nearness.

In some embodiments, the first replacement graphical element is generated based on a contextual prompt derived from the visual context of the first graphical element and the one or more additional contexts associated with the first graphical element.

In some embodiments, the processing circuitry generates the first replacement graphical element based on the contextual prompt using a text-to-image conversion model.

In some embodiments, the processing circuitry is further configured to generate a first prompt for the visual context of the first graphical element, generate one or more additional prompts for the one or more additional contexts associated with the first graphical element, respectively, and generate the contextual prompt based on the first prompt and the one or more additional prompts.

In some embodiments, the processing circuitry is further configured to assign a weight to each of the first prompt and the one or more additional prompts based on a contribution of the associated context in replacement graphical element generation. The contextual prompt is generated further based on each assigned weight.

In some embodiments, the contextual prompt comprises information associated with at least one of a tone of the first replacement graphical element, a luminosity of the first replacement graphical element, a saturation of the first replacement graphical element, or one or more complementary colors in the first replacement graphical element.

In some embodiments, the contextual prompt comprises information associated with at least one of a setting of the first replacement graphical element, an activity defined by the first replacement graphical element, a degree of movement associated with the first replacement graphical element, one or more objects in the first replacement graphical element, one or more object accessories in the first replacement graphical element, or a type of object accessory in the first replacement graphical element.

In some embodiments, the contextual prompt comprises locale information associated with the first replacement graphical element.

In some embodiments, the processing circuitry is further configured to replace the plurality of graphical elements in the source file with the plurality of replacement graphical elements to generate a replacement file, compare the replacement file and the source file to determine a degree of similarity between the replacement file and the source file, and modify the contextual prompt based on the degree of similarity being outside a tolerance range.

In some embodiments, the processing circuitry is further configured to generate an intermediate prompt based on the first prompt and the one or more additional prompts, and tune the intermediate prompt based on a set of predefined rules associated with the system. The contextual prompt corresponds to the tuned intermediate prompt.

In some embodiments, the tuning of the intermediate prompt corresponds to addition of a list of positive keywords and a list of negative keywords associated with a desired outcome. The list of positive keywords and the list of negative keywords are derived from the set of predefined rules.

In some embodiments, the source file corresponds to at least one of a group consisting of a code of an application page, a uniform resource locator (URL) of the application page, or a screen capture of the application page.

In some embodiments, a graphical element, of the plurality of graphical elements, corresponds to at least one of a group consisting of an image, an icon, a symbol, or a tag.

In some embodiments, the processing circuitry is further configured to receive one or more triggers. The processing circuitry detects the plurality of graphical elements in response to the one or more triggers.

In some embodiments, the one or more triggers correspond to at least one of a group consisting of a user input, lapse of a periodic time interval, or occurrence of a predetermined event.

In some embodiments, the source file corresponds to a plurality of pages of a website. On each page of the plurality of pages, the processing circuitry detects a set of graphical elements, of the plurality of graphical elements, and generates a corresponding set of replacement graphical elements, of the plurality of replacement graphical elements.

In some embodiments, a context-based graphical element replacement method is disclosed. The method comprises detecting, by processing circuitry, a plurality of graphical elements in a source file. The method further comprises determining, by the processing circuitry, a visual context of a first graphical element of the plurality of graphical elements. Further, the method comprises determining, by the processing circuitry, one or more additional contexts associated with the first graphical element. The one or more additional contexts comprise at least one of a group consisting of (i) a context associated with information present within a predefined range of the first graphical element, (ii) a visual context of at least one other graphical element of the plurality of graphical elements, or (iii) a context associated with the source file. The method further comprises generating, by the processing circuitry, a plurality of replacement graphical elements for the plurality of graphical elements, with a first replacement graphical element being generated for the first graphical element based on the visual context of the first graphical element and the one or more additional contexts associated with the first graphical element.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an environment for context-based graphical element replacement, consistent with disclosed embodiments of the present disclosure;

FIG. 2 is a block diagram of processing circuitry of the environment of FIG. 1, consistent with disclosed embodiments of the present disclosure;

FIG. 3A is a schematic diagram that illustrates an example source file, consistent with disclosed embodiments of the present disclosure;

FIG. 3B is a schematic diagram that illustrates an example replacement file, consistent with disclosed embodiments of the present disclosure;

FIG. 4 shows an example computing system for carrying out the methods of the present disclosure, consistent with disclosed embodiments of the present disclosure; and

FIGS. 5A and 5B, collectively, represents a flowchart that illustrates a method for context-based graphical element replacement, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Existing digital data processing technologies have made significant strides in various areas including digital data enhancement, modification, and analysis. For example, there is a push towards more sophisticated techniques such as image inpainting and style transfer. Image inpainting attempts to fill in missing or corrupted parts of an image, whereas style transfer alters the appearance of an image to mimic a particular artistic style. These approaches generally focus on aesthetic modifications. Hence, the context associated with an image may be lost during modification. Further, some of these solutions may heavily rely on predefined templates or static rules to enhance or modify an image, rendering them ineffective in different settings. These solutions then require extensive manual input to operate effectively. Human dependency may make the process intensive and error prone and may not even be feasible in certain cases.

The present disclosure addresses these limitations by providing a system and method for context-based graphical element replacement. Various graphical elements (e.g., images, icons, symbols, tags, or the like) may be detected in a source file. The source file may be a code of an application page, a uniform resource locator (URL) of the application page, or a screen capture of the application page. For each graphical element, a visual context associated therewith and one or more additional contexts are determined. The additional contexts may include a context associated with information present within a predefined range of the graphical element, a visual context of at least one other graphical element in the source file, and/or a context associated with the source file.

Prompts are generated for all the contexts, and weights are assigned to the prompts based on contribution of the associated contexts in replacement graphical element generation. Further, a contextual prompt may be generated for each graphical element. The contextual prompt may be derived from the individual prompts generated for all the contexts and the weights assigned thereto. In some embodiments, an intermediate prompt may be generated based on the individual prompts and the weights assigned thereto, and the intermediate prompt may be tuned based on a set of predefined rules to generate the contextual prompt. The tuning may correspond to the addition of a list of positive keywords and a list of negative keywords associated with a desired outcome.

A replacement graphical element is then generated for each graphical element based on the corresponding contextual prompt. The replacement graphical element may be generated using a text-to-image conversion model. Replacement graphical elements may thus be generated for all detected graphical elements in the source file. The replacement graphical elements may be contextually analogous to and visually different from the graphical elements in the source file. The graphical elements in the source file may then be replaced with the replacement graphical elements to generate a replacement file. The replacement file may be validated, and the validated replacement file may be rendered on a user device.

The present disclosure may thus allow for automated context-based graphical element replacement. In other words, the techniques of the present disclosure may enable dynamic replacement of original graphical elements with synthetically generated ones, while maintaining or enhancing the contextual relevance of the source file. Such methods enable seamless integration of synthetic imagery in diverse applications, including media production, virtual environments, and personalized content delivery, thereby offering improved user engagement and contextual accuracy. Further, the techniques of the present disclosure are devoid of any human intervention. Therefore, human errors may also be avoided. The application area of the present disclosure may include any domain that utilizes context-based analysis of graphical elements. It is appreciated that the human mind is not equipped to conceptualize and engineer graphical element replacement on vast platforms such as various application pages of a website, given the digital interconnectedness of graphical element replacement on vast platforms.

### Figure Description

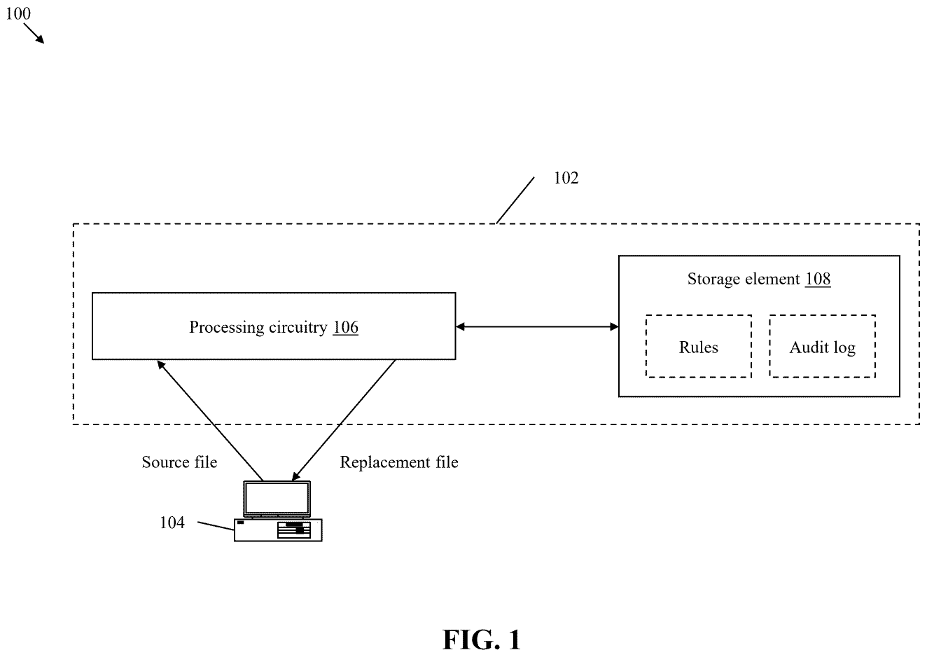

FIG. 1 is a schematic diagram that illustrates an environment 100 for context-based graphical element replacement, consistent with disclosed embodiments of the present disclosure. Applications such as web designing, content creation, or the like, involve graphical element replacement at a large scale. Examples of a graphical element may include an image, an icon, a symbol, a tag, or the like. Typically, this replacement may be human-driven. Human dependency may render this process inefficient, time-consuming, and often inaccurate. For example, it may not be feasible for a human to manually replace all graphical elements of various application pages of a website. Additionally, errors in replacement element selection are likely in such human-dependent scenarios.

To overcome these challenges, an automated context-based graphical element replacement technique is disclosed in the present disclosure. The environment 100 may include a graphical element replacement system 102. The graphical element replacement system 102 may be configured to execute the automated context-based graphical element replacement technique.

The graphical element replacement system 102 may be configured to receive a source file. The source file may correspond to at least one of a group consisting of a code of an application page, a uniform resource locator (URL) of the application page, or a screen capture of the application page. The application page may be associated with a website, a software application, or the like. The environment 100 may further include a user device 104. The user device 104 may correspond to a cell-phone, a laptop, a tablet, a phablet, a desktop, a computer, or the like. The user device 104 may be associated with a user (not shown). The user device 104 may include suitable logic, circuitry, interfaces, and/or code, executable by the circuitry, that may be configured to perform one or more operations for interacting with the graphical element replacement system 102. For example, the user device 104 may be used by the user to provide the source file to the graphical element replacement system 102.

The graphical element replacement system 102 may be configured to detect various graphical elements in the source file and generate replacement graphical elements for the detected graphical elements. A replacement graphical element is generated for each detected graphical element based on at least one of a visual context of the detected graphical element, a context associated with information present within a predefined range of the detected graphical element, a visual context of at least one other graphical element in the source file, or a context associated with the source file. Further, the graphical element replacement system 102 may be configured to replace the graphical elements in the source file with the replacement graphical elements to generate a replacement file. The replacement file thus includes newly generated graphical elements that are contextually analogous to and visually different from the original graphical elements. The graphical element replacement system 102 may thus execute the automated context-based graphical element replacement technique.

The graphical element replacement system 102 thus provides a suitable environment for updating the websites, software applications, or the like, as per the requirement in terms of visual content as well as look and feel. The graphical element replacement system 102 may parse through every single graphical content on various webpages of a website, interpret the context, and generate congruous visual content to replace the original ones. All these operations are executed in real time and without any human intervention. Therefore, the human errors introduced during manual replacement may be avoided. Notably, the time introduced due to manual replacement may be significantly reduced due to the automated real-time replacement technique implemented in the present disclosure, thereby further increasing the efficiency.

The present disclosure may be implemented in retail, commerce, telecom, media, insurance, automotive, financial services, travel, transportation, logistics, real estate, public and social sector, sports, energy, mining, industrial, healthcare, education, consumer packaged goods, or the like. Further, the techniques of the present disclosure may be utilized in website development, web application development, software development, development of code to be distributed via marketplaces, development of code to be distributed via public repositories, development of code to be distributed via private repositories, website quality assurance testing, web application assurance quality testing, software quality assurance testing, end-customer transactional experiences, customer support experiences, assisted in-store experiences, assisted online experiences, or the like.

To execute the aforementioned operations, the graphical element replacement system 102 may include processing circuitry 106 and a storage element 108. The storage element 108 may correspond to hardware storage (for example, hard drive, solid-state drive, or the like) or cloud storage (for example, cloud services).

The processing circuitry 106 may include suitable logic, circuitry, interfaces, and/or code, executable by the circuitry, that may be configured to contextually replace graphical elements. The processing circuitry 106 may be configured to receive the source file including various graphical elements. Examples of the graphical elements may include images, icons, symbols, tags, or the like. For the sake of simplicity, in FIG. 1, the replacement of images is described in detail. However, other graphical elements may be replaced in a similar manner, without deviating from the scope of the present disclosure. The processing circuitry 106 may be further configured to detect various images (e.g., graphical elements) in the source file.

For each detected image, the processing circuitry 106 may be further configured to determine a visual context of the detected image and one or more additional contexts associated with the detected image. The one or more additional contexts may include at least one of a context associated with information present within a predefined range of the detected image, a visual context of at least one other detected image, or a context associated with the source file. The processing circuitry 106 may be further configured to generate a replacement image for each detected image based on the visual context of the detected image and the one or more additional contexts associated with the detected image. In several embodiments, the replacement image may also be generated based on a set of rules (hereinafter referred to as “rules”) associated with the graphical element replacement system 102. The rules may define the guidelines associated with a desired outcome, and hence, may be utilized for the replacement image generation. In an embodiment, the storage element 108 may be configured to store the rules, and the processing circuitry 106 may be configured to access the storage element 108 for retrieving the rules prior to the generation of the replacement images.

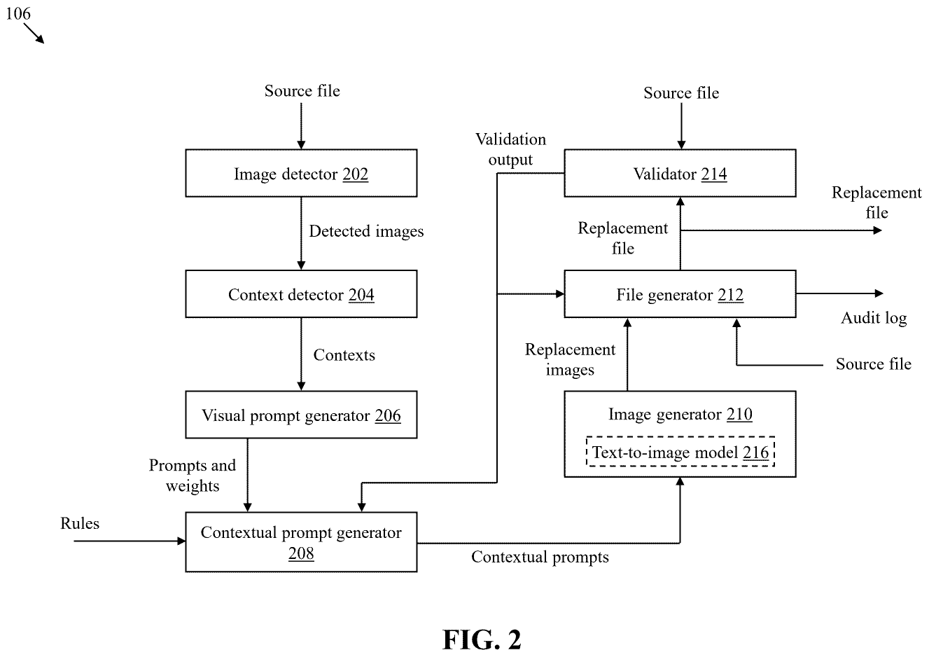

The processing circuitry 106 may be further configured to replace the images in the source file with the replacement images to generate the replacement file. In an embodiment, the generation of the replacement file may be a destructive process (e.g., the source file cannot be recreated from the replacement file). In another embodiment, the generation of the replacement file may be a reversible process. In such a scenario, the processing circuitry 106 may be configured to create an audit log that includes information associated with the source file and the replacement file that can be utilized for the recreation of the source file from the replacement file. Further, in the audit log, an entry is created for each image, and each replacement image may include metadata associated with the corresponding entry. Further, the processing circuitry 106 may be configured to render the replacement file on the user device 104. The replacement file may thus be presented to the user. The operations of the processing circuitry 106 are described in detail in conjunction with FIG. 2.

FIG. 2 is a block diagram of the processing circuitry 106, consistent with disclosed embodiments of the present disclosure. As illustrated in FIG. 2, the processing circuitry 106 may include an image detector 202, a context detector 204, a visual prompt generator 206, a contextual prompt generator 208, an image generator 210, a file generator 212, and a validator 214.

The image detector 202 may be coupled to the user device 104. The image detector 202 may include suitable logic, circuitry, interfaces, and/or code, executable by the circuitry, that may be configured to perform one or more operations. For example, the image detector 202 may be configured to receive the source file from the user device 104. The image detector 202 may be further configured to detect a plurality of graphical elements in the source file. A graphical element, of the plurality of graphical elements, corresponds to at least one of a group consisting of an image, an icon, a symbol, or a tag. For the sake of simplicity, in FIG. 2, it is assumed that the graphical elements are images. In an embodiment, the image detector 202 may be configured to receive one or more triggers. The one or more triggers may correspond to at least one of a group consisting of a user input, lapse of a periodic time interval, or occurrence of a predetermined event (e.g., an update to the content of the source file). The image detector 202 may detect the plurality of images in response to the one or more triggers.

The context detector 204 may be coupled to the image detector 202. The context detector 204 may include suitable logic, circuitry, interfaces, and/or code, executable by the circuitry, that may be configured to perform one or more operations. For example, the context detector 204 may receive, from the image detector 202, the plurality of images (hereinafter referred to as “images”) detected in the source file. The context detector 204 may be further configured to determine a visual context of a first image. Further, the context detector 204 may be configured to determine one or more additional contexts associated with the first image. The context detector 204 may determine the one or more additional contexts based on at least one of a code analysis or a visual analysis of the source file. The visual analysis may correspond to analysis of at least one of a group consisting of whitespaces, lines, color, contrast, or nearness. The context detection may involve recognizing objects, scenes, and underlying themes using a combination of object detection and scene understanding algorithms. The context detection may also involve recognizing the light intensity, luminosity, and placement of an image in the source file.

The one or more additional contexts may include a context associated with information present within a predefined range of the first image. The predefined range may correspond to a bounding box around the first image, a website section associated with the first image, or the like. The context associated with the information present within the predefined range of the first image may be at least one of visual or textual. The one or more additional contexts may further include a visual context of at least one other image of the plurality of images. In an embodiment, visual contexts of images in the vicinity of the first image may be utilized. The one or more additional contexts may further include a context associated with the source file. The context associated with the source file may be at least one of visual or textual.

The context detector 204 may determine the aforementioned contexts for each detected image. Thus, for each image, multiple levels of context are determined. These multiple levels of context may be utilized for contextually replacing each image in the source file.

The visual prompt generator 206 may be coupled to the context detector 204. The visual prompt generator 206 may include suitable logic, circuitry, interfaces, and/or code, executable by the circuitry, that may be configured to perform one or more operations. For example, the visual prompt generator 206 may be configured to receive, from the context detector 204, the contexts determined for the images. For the first image, the visual prompt generator 206 may be further configured to generate a first prompt for the visual context of the first image. Further, the visual prompt generator 206 may be configured to generate one or more additional prompts for the one or more additional contexts associated with the first image, respectively. The visual prompt generator 206 may be further configured to assign a weight to each of the first prompt and the one or more additional prompts based on a contribution of the associated context in replacement graphical element generation. The visual prompt generator 206 may generate various prompts and assign weights to the generated prompts for each detected image in the similar manner as described above.

The contextual prompt generator 208 may be coupled to the visual prompt generator 206 and the storage element 108. The contextual prompt generator 208 may include suitable logic, circuitry, interfaces, and/or code, executable by the circuitry, that may be configured to perform one or more operations. For example, the contextual prompt generator 208 may be configured to receive the prompts and weights associated with each image from the visual prompt generator 206. For the first image, the contextual prompt generator 208 may be configured to generate a first contextual prompt based on the first prompt, the one or more additional prompts, and the weight assigned to each of the first prompt and the one or more additional prompts.

In an embodiment, the contextual prompt generator 208 may be configured to generate an intermediate prompt for the first image based on the first prompt, the one or more additional prompts, and the weight assigned to each of the first prompt and the one or more additional prompts. Further, the contextual prompt generator 208 may be configured to access the storage element 108 to retrieve the rules stored therein. The contextual prompt generator 208 may be further configured to tune the intermediate prompt based on the retrieved rules. In such a scenario, the first contextual prompt may correspond to the tuned intermediate prompt. The tuning of the intermediate prompt corresponds to addition of a list of positive keywords and a list of negative keywords associated with a desired outcome. The list of positive keywords and the list of negative keywords may be derived from the rules. The list of positive keywords may define attributes to be present in the replacement image, whereas the list of negative keywords may define attributes to be absent in the replacement image. The tuning of the intermediate prompt may thus ensure that the first contextual prompt aligns with the contextual requirement.

Although it is described that an intermediate prompt is generated and the intermediate prompt is tuned to generate the first contextual prompt, the scope of the present disclosure is not limited to it. In various embodiments, the first contextual prompt may be derived directly based on the aggregation of the first prompt, the one or more additional prompts, and the weight assigned to each of the first prompt and the one or more additional prompts.

The first contextual prompt may be utilized for generating a first replacement image for the first image. In an embodiment, the first contextual prompt may include information associated with at least one of a tone of the first replacement image, a luminosity of the first replacement image, a saturation of the first replacement image, or one or more complementary colors in the first replacement image. The first contextual prompt may further include information associated with at least one of a setting of the first replacement image, an activity defined by the first replacement image, a degree of movement associated with the first replacement image, one or more objects in the first replacement image, one or more object accessories in the first replacement image, or a type of object accessory in the first replacement image. In several embodiments, the first contextual prompt may further include locale information associated with the first replacement image. The contextual prompt generator 208 may generate contextual prompts for each detected image in a similar manner as described above.

The image generator 210 may be coupled to the contextual prompt generator 208. The image generator 210 may include suitable logic, circuitry, interfaces, and/or code, executable by the circuitry, that may be configured to perform one or more operations. For example, the image generator 210 may be configured to receive the contextual prompts (e.g., the first contextual prompt) generated for the plurality of images from the contextual prompt generator 208. The image generator 210 may be configured to generate a plurality of replacement images for the plurality of graphical elements, with the first replacement image being generated for the first image. The first replacement image is contextually analogous to and visually different from the first image. The first replacement image may be generated based on the first contextual prompt derived from the visual context of the first image and the one or more additional contexts associated with the first image. In other words, the first replacement image may be generated based on the visual context of the first image and the one or more additional contexts associated with the first image. In an embodiment, the image generator 210 may include a text-to-image conversion model 216, and the image generator 210 may generate the first replacement image based on the first contextual prompt using the text-to-image conversion model 216. Examples of the text-to-image conversion model 216 may include Deep Autoregressive Language Learner (DALL)·E, MidJourney, Stable Diffusion, or the like. The image generator 210 may generate replacement images for other detected images in a similar manner as described above.

The file generator 212 may be coupled to the image generator 210 and the user device 104. The file generator 212 may include suitable logic, circuitry, interfaces, and/or code, executable by the circuitry, that may be configured to perform one or more operations. For example, the file generator 212 may be configured to receive the plurality of replacement images (hereinafter referred to as “replacement images”) from the image generator 210. Further, the file generator 212 may be configured to receive the source file from the user device 104. The file generator 212 may be further configured to replace the plurality of images in the source file with the plurality of replacement images to generate the replacement file.

In an embodiment, the generation of the replacement file may be a destructive process (e.g., the source file cannot be recreated from the replacement file). In another embodiment, the generation of the replacement file may be a reversible process. In such a scenario, the file generator 212 may be configured to encrypt each image (e.g., the first image) using an encryption key. Further, the file generator 212 may be configured to create the audit log, where each entry in the audit log includes a mapping between the encrypted image (e.g., the encrypted first image) and the encryption key. In such a scenario, each replacement image (e.g., the first replacement image) may include metadata associated with the corresponding entry (e.g., the first entry). The file generator 212 may be further coupled to the storage element 108, and configured to store the audit log in the storage element 108.

When the source file is required to be recreated, the file generator 212 may be further configured to obtain the metadata from each replacement image, access the storage element 108 (e.g., the audit log) to retrieve the encrypted original image and the encryption key, and decrypt the original image. The file generator 212 may thus be configured to recreate the source file from the replacement file based on the audit log.

The validator 214 may be coupled to the file generator 212, the user device 104, and the contextual prompt generator 208. The validator 214 may include suitable logic, circuitry, interfaces, and/or code, executable by the circuitry, that may be configured to perform one or more operations. For example, the validator 214 may be configured to receive the source file and the replacement file from the user device 104 and the file generator 212, respectively. The validator 214 may be further configured to validate the replacement file. To validate the replacement file, the validator 214 may be configured to compare the replacement file and the source file to determine a degree of similarity therebetween. The validator 214 may be further configured to generate a validation output based on the determined degree of similarity between the source file and the replacement file. Further, the validator 214 may be configured to provide the validation output to the file generator 212 and the contextual prompt generator 208.

Based on the degree of similarity being within a tolerance range, the replacement file is validated. In such a scenario, based on the validation output indicating that the degree of similarity is within the tolerance range, the file generator 212 may be further configured to render the replacement file on the user device 104. Conversely, based on the validation output indicating that the degree of similarity is outside the tolerance range, the file generator 212 may not render the replacement file on the user device 104. In such a scenario, the contextual prompt generator 208 may be configured to modify, based on the validation output, the contextual prompts (e.g., the first contextual prompt). The validation output may also indicate the images that need modification. The replacement file is then regenerated based on the modified contextual prompts and validated again. The process may repeat until the validation output indicates that the degree of similarity between the source file and the replacement file is within the tolerance range.

The functions of the validator 214 are not limited to the determination of the degree of similarity with the source file. In various embodiments, the validator 214 may be configured to check the replacement file for quality.

The processing circuitry 106 may thus contextually replace the images in the source file. In an example, the source file may correspond to a plurality of pages of a website. On each page of the plurality of pages, the processing circuitry 106 may detect a set of images, of the plurality of images, and generate a corresponding set of replacement images, of the plurality of replacement images. Thus, the processing circuitry 106 may execute image replacement in a website significantly faster and accurately, which may not even be feasible for the conventional human-driven image replacement method.

Other types of graphical elements may be replaced in a similar manner as described above.

In several embodiments, each of the image detector 202, the context detector 204, the visual prompt generator 206, the contextual prompt generator 208, the image generator 210, the file generator 212, and the validator 214 may be implemented using a machine learning model.

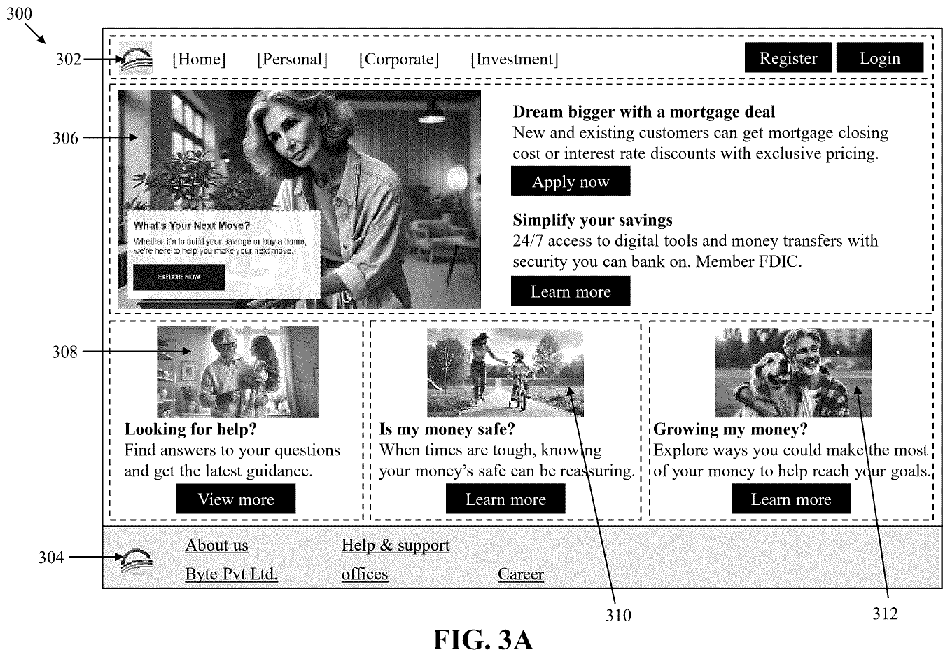

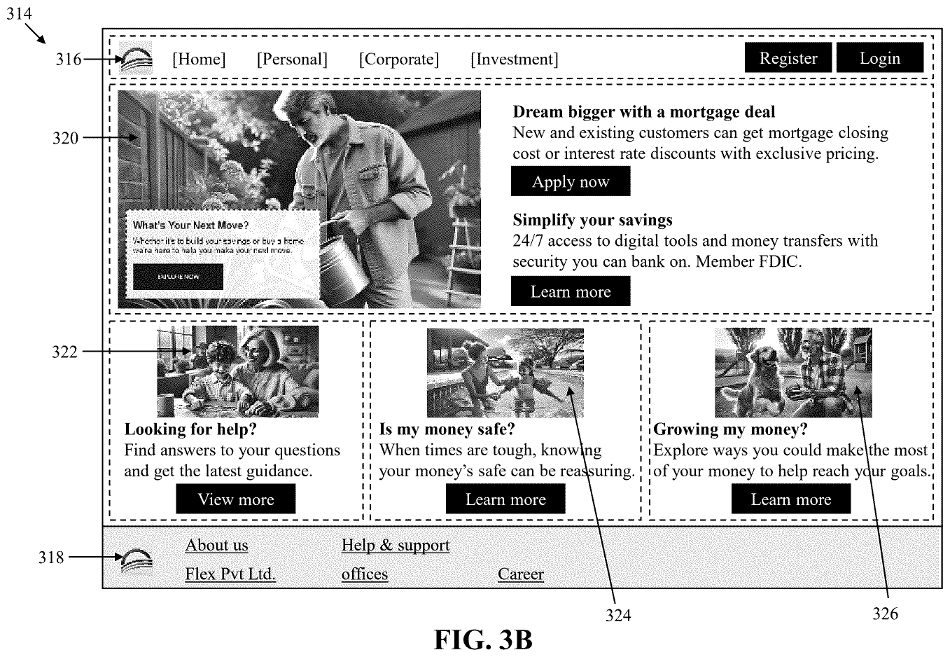

FIG. 3A is a schematic diagram that illustrates an example source file 300, consistent with disclosed embodiments of the present disclosure. The source file 300 may correspond to a webpage of a website. In an embodiment, the website may be associated with financial services. As illustrated in FIG. 3A, the source file 300 may include graphical elements 302-312. The graphical elements 302 and 304 may indicate a symbol (e.g., a logo). The graphical elements 306-312 may be images. The graphical element 306 may include a lady tending to a plant, whereas the graphical element 308 may include a man with a child. Further, the graphical element 310 may include a lady teaching a child how to ride a cycle, whereas the graphical element 312 may include a man with a pet. The graphical elements 306-312 along with their respective explanatory text are enclosed within separate boxes. The textual information in the vicinity of each image assists in interpreting the context along with its relevancy and connectivity to other images on the webpage.

The processing circuitry 106 may detect the graphical elements 302-312 in the source file 300. For the graphical element 306, the processing circuitry 106 may determine a visual context. The visual context may indicate a lady tending to a plant. The processing circuitry 106 may then determine the additional contexts. In this scenario, the additional contexts may include a textual context associated with the information in the vicinity of the graphical element 306. For example, the textual context may indicate money management. The additional contexts may also include visual contexts associated with the graphical elements 308-312. Further, the additional contexts may include textual and visual contexts associated with the source file 300. This may indicate that the source file 300 is associated with financial services.

For the graphical element 306, the processing circuitry 106 may generate various prompts for each determined context. For example, a prompt generated for the visual context of the graphical element 306 may correspond to “A close-up view of an older woman pruning a bonsai tree indoors, with her face clearly visible”. A prompt generated for the textual context of the information in the vicinity of the graphical element 306 may correspond to “Motivational text to support lifetime goal of buying a home”, a prompt for the visual context of other images may correspond to “Quality lifestyle indoors and outdoors in good weather condition”, and a prompt for the context of the source file 300 may correspond to “Long term financial education, tools, support”. The processing circuitry 106 may then assign weight to each prompt and generate an intermediate prompt based on the prompts and the assigned weights. The intermediate prompt may correspond to “Lifestyle benefits of wealth generation”. Further, the intermediate prompt may be tuned according to the rules to obtain the contextual prompt. The contextual prompt may correspond to “Long-term lifestyle benefits of financial planning, education, and wealth management”.

The scope of the present disclosure is not limited to the utilization of three levels of additional contexts for generating the contextual prompts. In various embodiments, any combination of the three may be utilized.

Such contextual prompts may be generated for each of the graphical elements 302-312. The contextual prompt generated for the graphical element 308 may correspond to “Intergenerational relationship”. Similarly, the contextual prompt generated for the graphical element 310 may correspond to “Lifetime skills”, and the contextual prompt generated for the graphical element 312 may correspond to “Quality Lifestyle”. Further, the contextual prompt generated for the graphical elements 302 and 304 may correspond to “Company Logo, bi-color, minimalist design”. The contextual prompts generated for each graphical element may be utilized for generating replacement graphical elements (shown in FIG. 3B).

FIG. 3B is a schematic diagram that illustrates an example replacement file 314, consistent with disclosed embodiments of the present disclosure. As illustrated in FIG. 3B, the replacement file 314 may include replacement graphical elements 316-326. The replacement graphical elements 316-326 may be generated based on the contextual prompts derived for the graphical elements 302-312, respectively. As illustrated in FIGS. 3A and 3B, the replacement file 314 is contextually analogous and visually different from the source file 300.

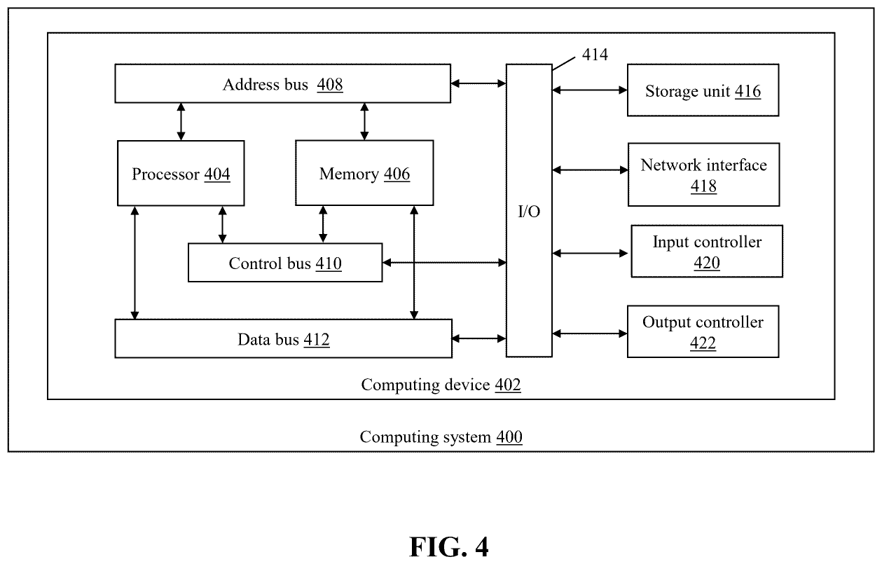

FIG. 4 shows an example computing system 400 for carrying out the methods of the present disclosure, consistent with disclosed embodiments of the present disclosure. Specifically, FIG. 4 shows a block diagram of an embodiment of the computing system 400 according to example embodiments of the present disclosure.

The computing system 400 may be configured to perform any of the operations disclosed herein. The computing system 400 can be implemented as a conventional computer system, an embedded controller, a laptop, a server, a mobile device, a smartphone, a customized machine, any other hardware platform, or any combination or multiplicity thereof. In one embodiment, the computing system 400 is a distributed system configured to function using multiple computing machines interconnected via a data network or bus system.

The computing system 400 includes computing devices (such as a computing device 402). The computing device 402 includes one or more processors (such as a processor 404) and a memory 406. The processor 404 may be any general-purpose processor(s) configured to execute a set of instructions. For example, the processor 404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 404 may be multiple processing units, a single processing core, multiple processing cores, special purpose processing cores, co-processors, or any combination thereof. The processor 404 may be communicatively coupled to the memory 406 via an address bus 408, a control bus 410, and a data bus 412.

The memory 406 may include non-volatile memories such as a read-only memory (ROM), a programable read-only memory (PROM), an erasable programmable read-only memory (EPROM), a flash memory, or any other device capable of storing program instructions or data with or without applied power. The memory 406 may also include volatile memories, such as a random-access-memory (RAM), a static random-access-memory (SRAM), a dynamic random-access-memory (DRAM), and a synchronous dynamic random-access-memory (SDRAM). The memory 406 may include single or multiple memory modules. While the memory 406 is depicted as part of the computing device 402, a person skilled in the art will recognize that the memory 406 can be separate from the computing device 402.

The memory 406 may store information that can be accessed by the processor 404. For instance, the memory 406 (e.g., one or more non-transitory computer-readable storage mediums, memory devices) may include computer-readable instructions (not shown) that can be executed by the processor 404. The computer-readable instructions may be software written in any suitable programming language or may be implemented in hardware. Additionally, or alternatively, the computer-readable instructions may be executed in logically and/or virtually separate threads on the processor 404. For example, the memory 406 may store instructions (not shown) that when executed by the processor 404 cause the processor 404 to perform operations such as any of the operations and functions for which the computing system 400 is configured, as described herein. Additionally, or alternatively, the memory 406 may store data (not shown) that can be obtained, received, accessed, written, manipulated, created, and/or stored. The data can include, for instance, the data and/or information described herein in relation to FIGS. 1-3. In some implementations, the computing device 402 may obtain from and/or store data in one or more memory device(s) that are remote from the computing system 400.

The computing device 402 may further include an input/output (I/O) interface 414 communicatively coupled to the address bus 408, the control bus 410, and the data bus 412. The data bus 412 may include a plurality of tunnels that may support communication in the environment 100. The I/O interface 414 is configured to couple to one or more external devices (e.g., to receive and send data from/to one or more external devices). Such external devices, along with the various internal devices, may also be known as peripheral devices. The I/O interface 414 may include both electrical and physical connections for operably coupling the various peripheral devices to the computing device 402. The I/O interface 414 may be configured to communicate data, addresses, and control signals between the peripheral devices and the computing device 402. The I/O interface 414 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 414 is configured to implement only one interface or bus technology. Alternatively, the I/O interface 414 is configured to implement multiple interfaces or bus technologies. The I/O interface 414 may include one or more buffers for buffering transmissions between one or more external devices, internal devices, the computing device 402, or the processor 404. The I/O interface 414 may couple the computing device 402 to various input devices, including touch screens, scanners, biometric readers, electronic digitizers, receivers, touchpads, cameras, keyboards, any other pointing devices, or any combinations thereof. The I/O interface 414 may couple the computing device 402 to various output devices, including printers, projectors, tactile feedback devices, automation control, robotic components, actuators, transmitters, signal emitters, lights, and so forth.

The computing system 400 may further include a storage unit 416, a network interface 418, an input controller 420, and an output controller 422. The storage unit 416, the network interface 418, the input controller 420, and the output controller 422 are communicatively coupled to the central control unit (e.g., the memory 406, the address bus 408, the control bus 410, and the data bus 412) via the I/O interface 414. The network interface 418 communicatively couples the computing system 400 to one or more networks such as wide area networks (WAN), local area networks (LAN), intranets, the Internet, wireless access networks, wired networks, mobile networks, telephone networks, optical networks, or combinations thereof. The network interface 418 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 416 is a computer-readable medium, preferably a non-transitory computer-readable medium, comprising one or more programs, the one or more programs comprising instructions which when executed by the processor 404 cause the computing system 400 to perform the method steps of the present disclosure. Alternatively, the storage unit 416 is a transitory computer-readable medium. The storage unit 416 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 416 stores one or more operating systems, application programs, program modules, data, or any other information. The storage unit 416 is part of the computing device 402. Alternatively, the storage unit 416 is part of one or more other computing machines that are in communication with the computing device 402, such as servers, database servers, cloud storage, network attached storage, and so forth.

The input controller 420 may include suitable logic, circuitry, interfaces, and/or code, executable by the circuitry, that may be configured to control one or more input devices that may be configured to receive a source file (e.g., the source file 300). The output controller 422 may include suitable logic, circuitry, interfaces, and/or code, executable by the circuitry, that may be configured to control one or more output devices that may be configured to render/output a replacement file (e.g., the replacement file 314) on the user device 104.

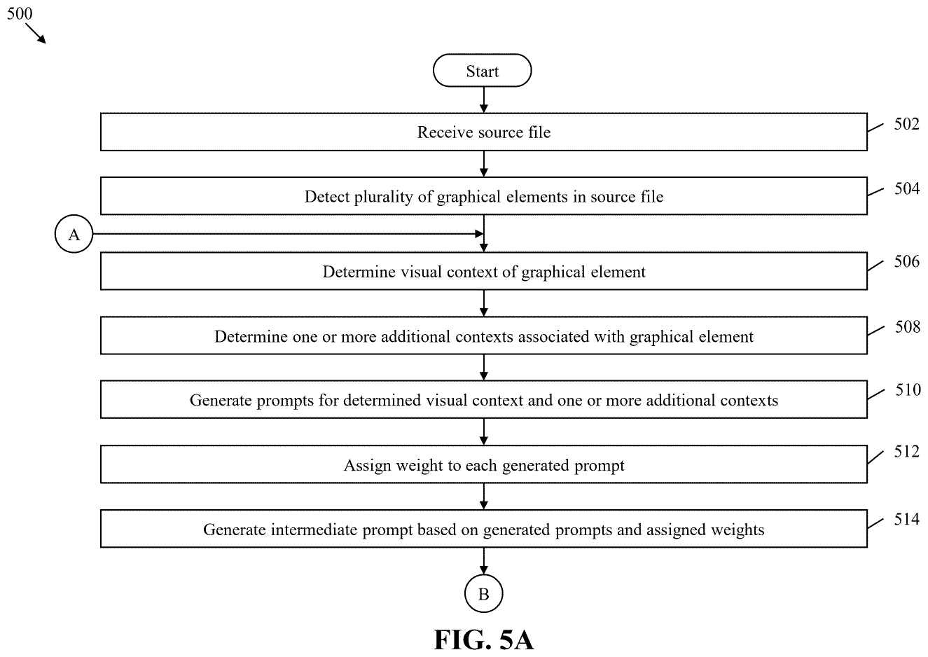

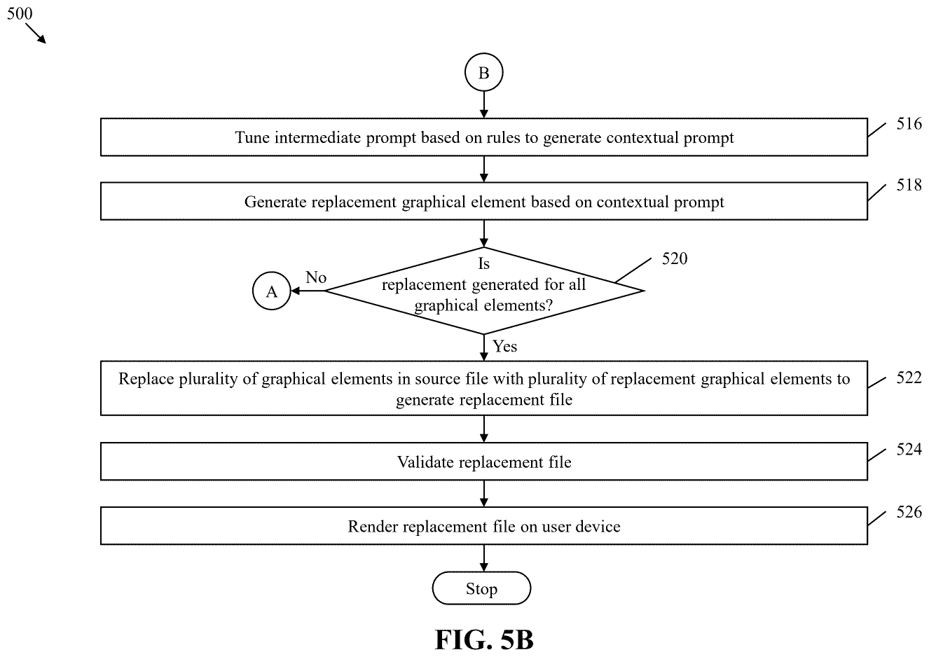

FIGS. 5A and 5B, collectively, represents a flowchart 500 that illustrates a method for context-based graphical element replacement, consistent with disclosed embodiments of the present disclosure.

Referring to FIG. 5A, at 502, the processing circuitry 106 (e.g., the image detector 202) may receive a source file (e.g., the source file 300). At 504, the processing circuitry 106 (e.g., the image detector 202) may detect a plurality of graphical elements in the source file. At 506, the processing circuitry 106 (e.g., the context detector 204) may determine a visual context of a graphical element. At 508, the processing circuitry 106 (e.g., the context detector 204) may determine one or more additional contexts associated with the graphical element. The one or more additional contexts may include at least one of a group consisting of a context associated with information present within a predefined range of the graphical element, a visual context of at least one other graphical element of the plurality of graphical elements, or a context associated with the source file.

At 510, the processing circuitry 106 (e.g., the visual prompt generator 206) may generate prompts for the determined visual context and one or more additional contexts. At 512, the processing circuitry 106 (e.g., the visual prompt generator 206) may assign a weight to each generated prompt. The weight may be assigned based on a contribution of the associated context in replacement image generation. At 514, the processing circuitry 106 (e.g., the contextual prompt generator 208) may generate an intermediate prompt based on the generated prompts and assigned weights.

Referring to FIG. 5B, at 516, the processing circuitry 106 (e.g., the contextual prompt generator 208) may tune the intermediate prompt based on the rules to generate a contextual prompt. At 518, the processing circuitry 106 (e.g., the image generator 210) may generate a replacement graphical element based on the contextual prompt. At 520, the processing circuitry 106 may determine whether the replacement is generated for all graphical elements. If at 520, it is determined that the replacement is not generated for all graphical elements, 506 is executed. Thus, 506-518 may be repeated for all graphical elements. If at 520, it is determined that the replacement is generated for all graphical elements, 522 is executed. At 522, the processing circuitry 106 (e.g., the file generator 212) may replace the plurality of graphical elements in the source file with a plurality of replacement graphical elements to generate a replacement file (e.g., the replacement file 314). At 524, the processing circuitry 106 (e.g., the validator 214) may validate the replacement file. At 526, the processing circuitry 106 (e.g., the file generator 212) may render the replacement file on the user device 104. The replacement file may be rendered on the user device 104 upon successful validation.

The scope of the present disclosure is not limited to the generation and tuning of the intermediate prompts. In numerous embodiments, the contextual prompt may be derived directly based on the aggregation of the prompts and the weights, without deviating from the scope of the present disclosure.

The disclosed embodiments encompass numerous advantages including an efficient and seamless approach to creating replacements for webpages of analogous products or of the same product in a different jurisdiction or region of the world. The graphical element replacement system 102 may parse through every single graphical content on various webpages of a website, interpret the context, and generate congruous visual content to replace the original ones. All these operations are executed in real time and sans any human intervention. Therefore, the human errors introduced during manual replacement may be avoided. Notably, the time introduced due to manual replacement may be significantly reduced due to the automated real-time replacement technique implemented in the present disclosure, thereby further increasing the efficiency.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods of context-based graphical element replacement. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

Moreover, for example, the present technology/system may achieve the following configurations:

1. A system, comprising:
processing circuitry configured to:
   detect a plurality of graphical elements in a source file;
   determine a visual context of a first graphical element of the plurality of graphical elements;
   determine one or more additional contexts associated with the first graphical element, wherein the one or more additional contexts comprise at least one of a group consisting of (i) a context associated with information present within a predefined range of the first graphical element, (ii) a visual context of at least one other graphical element of the plurality of graphical elements, or (iii) a context associated with the source file; and
   generate a plurality of replacement graphical elements for the plurality of graphical elements, with a first replacement graphical element being generated for the first graphical element based on the visual context of the first graphical element and the one or more additional contexts associated with the first graphical element.
      2. The system of 1, wherein the first replacement graphical element is contextually analogous to and visually different from the first graphical element.
      3. The system of 1, wherein the context associated with the information present within the predefined range of the first graphical element is at least one of visual or textual.
      4. The system of 1, wherein the context associated with the source file is at least one of visual or textual.
      5. The system of 1, wherein the processing circuitry is further configured to replace the plurality of graphical elements in the source file with the plurality of replacement graphical elements to generate a replacement file.
      6. The system of 5, wherein the processing circuitry is further configured to render the replacement file on a user device associated with the system.
      7. The system of 5, wherein the processing circuitry is further configured to validate the replacement file.
      8. The system of 7, wherein to validate the replacement file, the processing circuitry is further configured to compare the replacement file and the source file to determine a degree of similarity therebetween, and wherein the replacement file is validated based on the degree of similarity being within a tolerance range.
      9. The system of 5, wherein the processing circuitry is further configured to:
encrypt the first graphical element using an encryption key; and
create an audit log, where an entry in the audit log includes a mapping between the encrypted first graphical element and the encryption key, wherein the first replacement graphical element includes metadata associated with the entry.
   10. The system of 9, wherein the processing circuitry is further configured to recreate the source file from the replacement file based on the audit log.
   11. The system of 1, wherein the processing circuitry determines the one or more additional contexts based on at least one of a code analysis or a visual analysis of the source file.
   12. The system of 11, wherein the visual analysis corresponds to analysis of at least one of a group consisting of whitespaces, lines, color, contrast, or nearness.
   13. The system of 1, wherein the first replacement graphical element is generated based on a contextual prompt derived from the visual context of the first graphical element and the one or more additional contexts associated with the first graphical element.
   14. The system of 13, wherein the processing circuitry generates the first replacement graphical element based on the contextual prompt using a text-to-image conversion model.
   15. The system of 13, wherein the processing circuitry is further configured to:
generate a first prompt for the visual context of the first graphical element;
generate one or more additional prompts for the one or more additional contexts associated with the first graphical element, respectively; and
generate the contextual prompt based on the first prompt and the one or more additional prompts.
   16. The system of 15, wherein the processing circuitry is further configured to assign a weight to each of the first prompt and the one or more additional prompts based on a contribution of the associated context in replacement graphical element generation, and wherein the contextual prompt is generated further based on each assigned weight.
   17. The system of 13, wherein the contextual prompt comprises information associated with at least one of a tone of the first replacement graphical element, a luminosity of the first replacement graphical element, a saturation of the first replacement graphical element, or one or more complementary colors in the first replacement graphical element.
   18. The system of 13, wherein the contextual prompt comprises information associated with at least one of a setting of the first replacement graphical element, an activity defined by the first replacement graphical element, a degree of movement associated with the first replacement graphical element, one or more objects in the first replacement graphical element, one or more object accessories in the first replacement graphical element, or a type of object accessory in the first replacement graphical element.
   19. The system of 13, wherein the contextual prompt comprises locale information associated with the first replacement graphical element.
   20. The system of 13, wherein the processing circuitry is further configured to:
replace the plurality of graphical elements in the source file with the plurality of replacement graphical elements to generate a replacement file;
compare the replacement file and the source file to determine a degree of similarity between the replacement file and the source file; and
modify the contextual prompt based on the degree of similarity being outside a tolerance range.
   21. The system of 13, wherein the processing circuitry is further configured to:
generate a first prompt for the visual context of the first graphical element;
generate one or more additional prompts for the one or more additional contexts associated with the first graphical element, respectively;
generate an intermediate prompt based on the first prompt and the one or more additional prompts; and
tune the intermediate prompt based on a set of predefined rules associated with the system, wherein the contextual prompt corresponds to the tuned intermediate prompt.
   22. The system of 21, wherein the tuning of the intermediate prompt corresponds to addition of a list of positive keywords and a list of negative keywords associated with a desired outcome, and wherein the list of positive keywords and the list of negative keywords are derived from the set of predefined rules.
   23. The system of 1, wherein the source file corresponds to at least one of a group consisting of a code of an application page, a uniform resource locator (URL) of the application page, or a screen capture of the application page.
   24. The system of 1, wherein a graphical element, of the plurality of graphical elements, corresponds to at least one of a group consisting of an image, an icon, a symbol, or a tag.
   25. The system of 1, wherein the processing circuitry is further configured to receive one or more triggers, and wherein the processing circuitry detects the plurality of graphical elements in response to the one or more triggers.
   26. The system of 25, wherein the one or more triggers correspond to at least one of a group consisting of a user input, lapse of a periodic time interval, or occurrence of a predetermined event.
   27. The system of 1, wherein the source file corresponds to a plurality of pages of a website, and wherein on each page of the plurality of pages, the processing circuitry detects a set of graphical elements, of the plurality of graphical elements, and generates a corresponding set of replacement graphical elements, of the plurality of replacement graphical elements.
   28. A method, comprising:
detecting, by processing circuitry, a plurality of graphical elements in a source file;
determining, by the processing circuitry, a visual context of a first graphical element of the plurality of graphical elements;
determining, by the processing circuitry, one or more additional contexts associated with the first graphical element, wherein the one or more additional contexts comprise at least one of a group consisting of (i) a context associated with information present within a predefined range of the first graphical element, (ii) a visual context of at least one other graphical element of the plurality of graphical elements, or (iii) a context associated with the source file; and
generating, by the processing circuitry, a plurality of replacement graphical elements for the plurality of graphical elements, with a first replacement graphical element being generated for the first graphical element based on the visual context of the first graphical element and the one or more additional contexts associated with the first graphical element.

What is claimed is:

1. A system, comprising:
processing circuitry configured to:
detect a plurality of graphical elements in a source file;
determine a visual context of a first graphical element of the plurality of graphical elements;
determine one or more additional contexts associated with the first graphical element, wherein the one or more additional contexts comprise at least one of a group consisting of (i) a context associated with information present within a predefined range of the first graphical element, (ii) a visual context of at least one other graphical element of the plurality of graphical elements, or (iii) a context associated with the source file; and
generate a plurality of replacement graphical elements for the plurality of graphical elements, with a first replacement graphical element being generated for the first graphical element based on the visual context of the first graphical element and the one or more additional contexts associated with the first graphical element.

2. The system of claim 1, wherein the first replacement graphical element is contextually analogous to and visually different from the first graphical element.

3. The system of claim 1, wherein the processing circuitry is further configured to replace the plurality of graphical elements in the source file with the plurality of replacement graphical elements to generate a replacement file.

4. The system of claim 3, wherein the processing circuitry is further configured to render the replacement file on a user device associated with the system.

5. The system of claim 3, wherein the processing circuitry is further configured to validate the replacement file.

6. The system of claim 5,
wherein to validate the replacement file, the processing circuitry is further configured to compare the replacement file and the source file to determine a degree of similarity therebetween, and
wherein the replacement file is validated based on the degree of similarity being within a tolerance range.

7. The system of claim 1, wherein the processing circuitry determines the one or more additional contexts based on at least one of a code analysis or a visual analysis of the source file.

8. The system of claim 1, wherein the first replacement graphical element is generated based on a contextual prompt derived from the visual context of the first graphical element and the one or more additional contexts associated with the first graphical element.

9. The system of claim 8, wherein the processing circuitry generates the first replacement graphical element based on the contextual prompt using a text-to-image conversion model.

10. The system of claim 8, wherein the processing circuitry is further configured to:
generate a first prompt for the visual context of the first graphical element;
generate one or more additional prompts for the one or more additional contexts associated with the first graphical element, respectively; and
generate the contextual prompt based on the first prompt and the one or more additional prompts.

11. The system of claim 10,
wherein the processing circuitry is further configured to assign a weight to each of the first prompt and the one or more additional prompts based on a contribution of the associated context in replacement graphical element generation, and
wherein the contextual prompt is generated further based on each assigned weight.

12. The system of claim 8, wherein the contextual prompt comprises information associated with at least one of:
a tone of the first replacement graphical element,
a luminosity of the first replacement graphical element,
a saturation of the first replacement graphical element, or
one or more complementary colors in the first replacement graphical element.

13. The system of claim 8, wherein the contextual prompt comprises information associated with at least one of:
a setting of the first replacement graphical element,
an activity defined by the first replacement graphical element,
a degree of movement associated with the first replacement graphical element,
one or more objects in the first replacement graphical element,
one or more object accessories in the first replacement graphical element, or
a type of object accessory in the first replacement graphical element.

14. The system of claim 8, wherein the contextual prompt comprises locale information associated with the first replacement graphical element.

15. The system of claim 8, wherein the processing circuitry is further configured to:
replace the plurality of graphical elements in the source file with the plurality of replacement graphical elements to generate a replacement file;
compare the replacement file and the source file to determine a degree of similarity between the replacement file and the source file; and
modify the contextual prompt based on the degree of similarity being outside a tolerance range.

16. The system of claim 8, wherein the processing circuitry is further configured to:
generate a first prompt for the visual context of the first graphical element;
generate one or more additional prompts for the one or more additional contexts associated with the first graphical element, respectively;
generate an intermediate prompt based on the first prompt and the one or more additional prompts; and
tune the intermediate prompt based on a set of predefined rules associated with the system, wherein the contextual prompt corresponds to the tuned intermediate prompt.

17. The system of claim 16,
wherein the tuning of the intermediate prompt corresponds to addition of a list of positive keywords and a list of negative keywords associated with a desired outcome, and
wherein the list of positive keywords and the list of negative keywords are derived from the set of predefined rules.

18. The system of claim 1, wherein the source file corresponds to at least one of a group consisting of a code of an application page, a uniform resource locator (URL) of the application page, or a screen capture of the application page.

19. The system of claim 1,
wherein the source file corresponds to a plurality of pages of a website, and
wherein on each page of the plurality of pages, the processing circuitry detects a set of graphical elements, of the plurality of graphical elements, and generates a corresponding set of replacement graphical elements, of the plurality of replacement graphical elements.

20. A method, comprising:
detecting, by processing circuitry, a plurality of graphical elements in a source file;
determining, by the processing circuitry, a visual context of a first graphical element of the plurality of graphical elements;
determining, by the processing circuitry, one or more additional contexts associated with the first graphical element, wherein the one or more additional contexts comprise at least one of a group consisting of (i) a context associated with information present within a predefined range of the first graphical element, (ii) a visual context of at least one other graphical element of the plurality of graphical elements, or (iii) a context associated with the source file; and
generating, by the processing circuitry, a plurality of replacement graphical elements for the plurality of graphical elements, with a first replacement graphical element being generated for the first graphical element based on the visual context of the first graphical element and the one or more additional contexts associated with the first graphical element.
